(19) United States
(12) Patent Application Publication
(10) Pub. No.: US 2004/0066075 A1
(43) Pub. Date: Apr. 8, 2004

(54) Structure for adjusting backrest for collapsible chairs

(76) Inventor: Chin-Chung Yeh, Hsin Tien City (TW)

Correspondence Address: Leong C. LEI, PMB #1008, 1867 Ygnacio Valley Road, WALNUT CREEK, CA, 94598-3214, US

(21) Appl. No.: 10/265,117

(22) Filed: Oct. 7, 2002

(51) Int. Cl. B60N 2/02

(52) U.S. Cl. 297/354.1

(57) ABSTRACT

A chair includes a base support having two upwardly extending rods and two upwardly extending tubular members, a seat mounted on the base support and having a backrest, two armrests each having an end fixedly mounted on a respective one of the upwardly extending rods, two lower rods each inserted into a respective one of the upwardly extending tubular members, a spring sleeved over the upper portion of the lower rod with a lower end of the spring bearing against the flange of the lower rod, an upper rod formed with a flange at an intermediate portion and two downwardly extending lugs, the inclined surface of the lower rod being used for limiting rotation angle of the upper rod with respect to the lower rod, a backrest rod being put onto an upper end of the upper rod, the backrest rod extending upwardly through another end of a respective one of the armrests to engage fixedly with the backrest, and an adjusting means connected between the backrest and rear ends of the armrests, thereby providing different positions of the backrest with respect to the seat and armrest for the user.

### BACKGROUND OF THE INVENTION

1. Field of the Invention

This invention is related to a structure for adjusting backrest for casual chairs and in particular to one which can provide different positions of the backrest with respect to the seat and armrest for the user.

2. Description of the Prior Art

The conventional casual chair simply includes a base support on which is mounted a seat made of flexible material. Such chairs are not comfortable and so improved casual chairs with armrests have been proposed to obviate this drawback. However, such improved casual chairs do not have an adjustable rest for the back thereby making them unable to provide a comfortable feeling for the user.

Therefore, it is an object of the present invention to provide a structure for adjusting the backrest of a collapsible chair which can obviate and mitigate the above-mentioned drawbacks.

### SUMMARY OF THE INVENTION

This invention is related to a structure for adjusting backrest for casual chairs.

It is the primary object of the present invention to provide structure for adjusting backrest for casual chairs which can provide different positions of the backrest with respect to the seat and armrest for the user.

According to a preferred embodiment of the present invention, a chair includes a base support having two upwardly extending rods and two upwardly extending tubular members, a seat mounted on the base support and having a backrest, two armrests each having an end fixedly mounted on a respective one of the upwardly extending rods, two lower rods each inserted into a respective one of the upwardly extending tubular members, a spring sleeved over the upper portion of the lower rod with a lower end of the spring bearing against the flange of the lower rod, an upper rod formed with a flange at an intermediate portion and two downwardly extending lugs, the inclined surface of the lower rod being used for limiting rotation angle of the upper rod with respect to the lower rod, a backrest rod being put onto an upper end of the upper rod, the backrest rod extending upwardly through another end of a respective one of the armrests to engage fixedly with the backrest, and an adjusting means connected between the backrest and rear ends of the armrests, thereby providing different positions of the backrest with respect to the seat and armrest for the user.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2 is an exploded view of a portion of the present invention;

FIG. 3 is a sectional view showing the rotation of the upper rod with respect to the lower rod;

FIG. 4 illustrates the relationship between the two straps;

FIG. 4A is a perspective view of the buckle; and

FIG. 5 is a working view of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

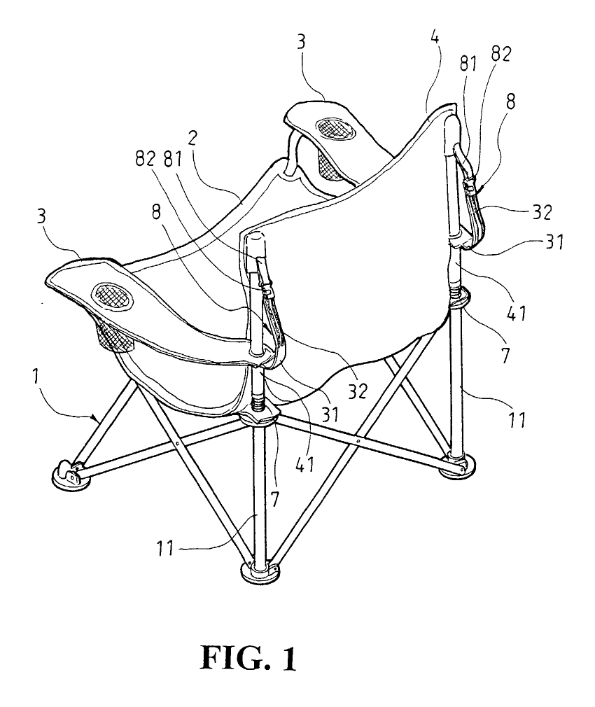

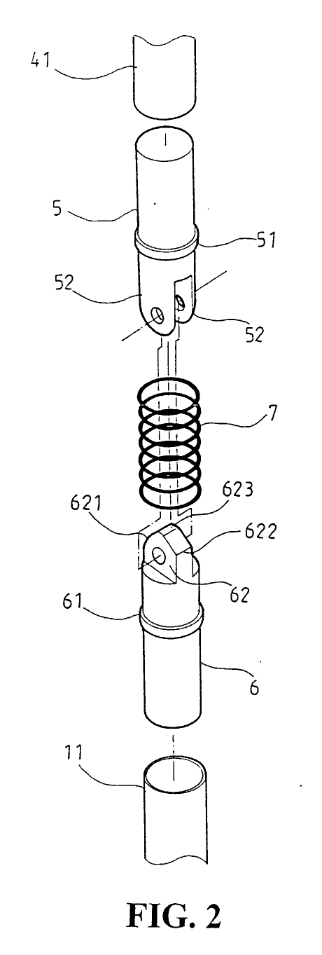

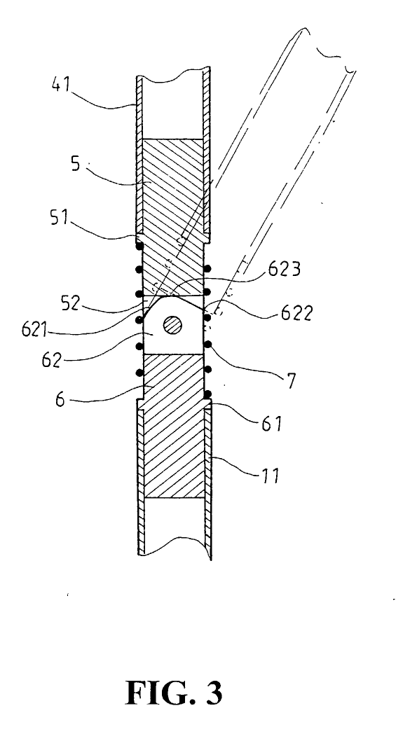

With reference to the drawings and in particular to FIGS. 1, 2 and 3 thereof, the present invention comprises a base support 1, a seat 2, a pair of armrests 3, and a backrest 4. The base support 1 is provided with two upwardly extending tubular members 11 in each of which is inserted a lower rod 6. The lower rod 6 is formed with a flange 6 at the intermediate portion thereof and a rib 62 at the upper end thereof. The rib 62 is formed with a flat top 623, a curved surface 621 at one side of the flat top 623, and an inclined surface 622 at the other side of the flat top 622. A spring 7 is sleeved over the upper portion of the lower rod 6, with its lower end bearing against the flange 6 of the lower rod 6. An upper rod 5 is formed with a flange 51 at the intermediate portion and two downwardly extending lugs 52. The lower rod 6 is pivotally connected with the upper rod 5, so that the rib 62 of the former is pivotally fitted between the two lugs 52 of the latter by a pin (shown in FIG. 3 but not numbered) and the spring 7 is fitted between the flanges 51 and 61, thereby enabling the upper rod 5 to be rotated with respect to the lower rod 6. The inclined surface 622 of the lower rod 6 is used for limiting the rotation angle of the upper rod 5 with respect to the lower rod 6 (see FIG. 3). A backrest rod 41 is put onto the upper end of the upper rod 5. The backrest rod 41 extends upwardly through the rear end of the armrest 3 to engage fixedly with the backrest 4.

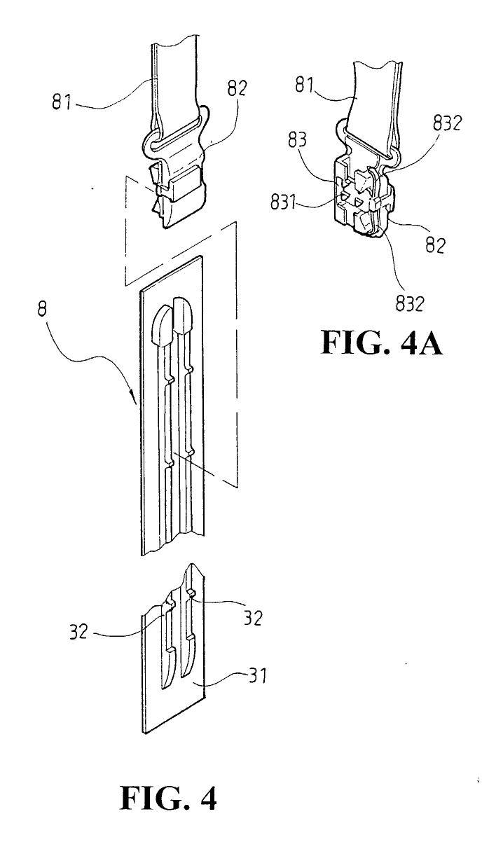

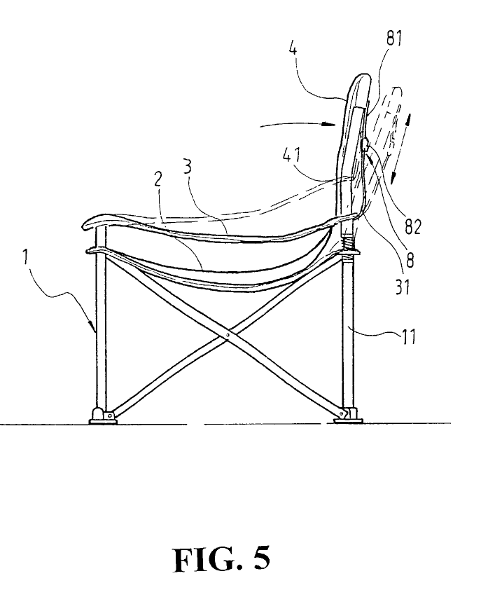

As shown in FIGS. 3, 4, 4A and 5, an adjusting means 8 comprises a first strap 31 and a second strap 81. The first strap 31 extends from the rear end of the armrest 3 and is provided with a plurality of teeth 32. The second strap 81 extends through the upper end of the backrest 4 and is provided with a buckle 82. The buckle 82 has a recess 83 provided with a plurality of hooks 831 and two resilient members 832 mounted at one side of the recess 83, so that when the first strap 31 is inserted into the buckle 82 of the second strap 81, the teeth 32 of the first strap 31 will engage with the hooks 831 of the buckle 82 thereby enabling the engagement between the first and second straps 31 and 81 to be adjusted as desired.

When desired to adjust the inclination of the backrest 4, it is only necessary to adjust the position of the buckle 82 with respect to the first strap 31 so as to adjust the position of the rear end of the armrest 3. When the buckle 82 is adjusted to different positions, the rear end of the armrest 3 will be moved to different positions too thereby providing different positions of the backrest 4 with respect to the seat 2 and armrest 3 for the user. When the user stands up, the spring 7 will push the backrest 4 back to its original position.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A chair comprising:
a base support having two upwardly extending rods and two upwardly extending tubular members;
a seat mounted on said base support and having a backrest;
two armrests each having an end fixedly mounted on a respective one of said upwardly extending rods;
each of said upwardly extending tubular members extending upwardly through said seat;
two lower rods each inserted into a respective one of said upwardly extending tubular members, said lower rod being formed with a flange at an intermediate portion thereof and a rib at an upper end thereof, said rib being formed with a flat top, a curved surface at one side of said flat top, and an inclined surface at another side of said flat top, a spring sleeved over said upper portion of said lower rod with a lower end of said spring bearing against said flange of said lower rod, an upper rod formed with a flange at an intermediate portion and two downwardly extending lugs, said lower rod being pivotally connected with said upper rod so that said rib is pivotally fitted between said two lugs and said spring is fitted between sad flanges thereby enabling said upper rod to be rotated with respect to said lower rod, said inclined surface of said lower rod being used for limiting rotation angle of said upper rod with respect to said lower rod, a backrest rod being put onto an upper end of said upper rod, said backrest rod extending upwardly through another end of a respective one of said armrests to engage fixedly with said backrest; and
an adjusting means connected between said backrest and rear ends of said armrests.

2. The chair as claimed in claim 1, wherein said adjusting means comprises two first straps each extending from a rear end of a respective one of said armrests and provided with a plurality of teeth, and two second straps extending through an upper end of said backrest and provided with a buckle, said buckle having a recess provided with a plurality of hooks and two resilient members mounted at one side of said recess, so that when each of said first straps is inserted into said buckle, said teeth of said first straps will engage with said hooks of said buckle thereby enabling engagement between said first and second straps to be adjusted.
